(19) United States
(12) Patent Application Publication
(10) Pub. No.: US 2006/0167193 A1
(43) Pub. Date: Jul. 27, 2006

(54) Regulation of the continuous ethylene polymerization process in a high-pressure reactor

(75) Inventors: Frank-Olaf Mahling, Mannheim (DE); Christian-Ulrich Schmidt, Bonn (DE); Angelika Altmann-Dieses, Deisdesheim (DE); Andreas Daiss, Mannheim (DE)

Correspondence Address: BASELL USA INC., INTELLECTUAL PROPERTY, 912 APPLETON ROAD, ELKTON, MD, 21921, US

(73) Assignee: Basell Polyolefine GmbH, Wesseling (DE)

(21) Appl. No.: 10/547,651

(22) PCT Filed: Mar. 3, 2004
(86) PCT No.: PCT/EP04/02111

§ 371 Date: Sep. 1, 2005

Related U.S. Application Data
(60) Provisional application No. 60/460,641, filed on Apr. 4, 2003.

(30) Foreign Application Priority Data
Mar. 6, 2003 (DE) 103 10 037.7

(51) Int. Cl. C08F 2/00

(52) U.S. Cl. 526/64

(57) ABSTRACT

Method of regulating the process for the continuous free-radical polymerization of ethylene in the presence or absence of comonomers in a tube reactor having at least one reaction zone (1, 2, 3, 4) at pressures above 1000 bar and temperatures in the range from 100 to 400° C., wherein a mixture of at least two polymerization initiators which have different reaction characteristics and provision costs, in particular purchase prices, is metered continuously into the tube reactor at the beginning of each reaction zone (1, 3, 3, 4), at least one physical parameter which as an influence on the polymerization initiator mixture to be used is measured at prescribed intervals in each reaction zone (, 2, 3, 4), the mixture of polymerization initiators which under the prevailing conditions of the physical parameter or parameters measured results in the minimum initiator costs for producing a prescribed amount of polymer product having prescribed product properties and ensures sage operation of the tube reactor is calculated in an optimizer for each reaction zone (1, 2, 3, 4) and, finally, the calculated amount and composition of the polymerization initiators is used as the basis for the further metered additions.

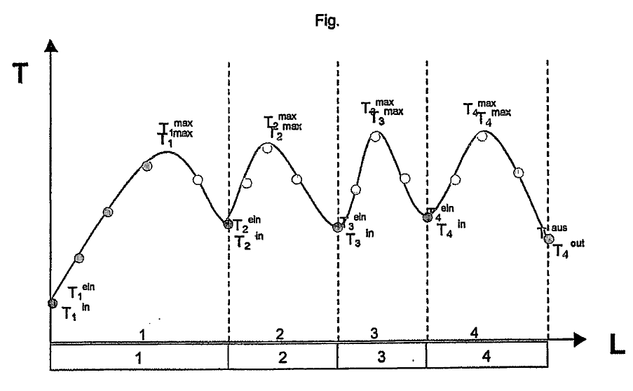

The present invention relates to a method of controlling the process for the continuous free-radical polymerization of ethylene homopolymers and copolymers in a tube reactor having at least one reaction zone at pressures above 1000 bar and temperatures in the range from 100 to 400° C., wherein
a mixture of at least two polymerization initiators which have different reaction characteristics and provision costs is metered continuously into the tube reactor at the beginning of the reaction zone,
at least one physical parameter which has an influence on the polymerization initiator mixture to be used is measured in the reaction zone,
the mixture of polymerization initiators which under the prevailing conditions of the physical parameter or parameters measured results in the minimum initiator costs for producing a prescribed amount of polymer product having prescribed product properties and ensures safe operation of the tube reactor is calculated for the reaction zone, and
the calculated amount and composition of the polymerization initiators is used as the basis for the further metered addition.

High-pressure polymerization processes for preparing polyethylene and ethylene copolymers using oxygen or organic free-radical formers as initiators have been known for a long time. Processes of this type which are carried out in high-pressure tube reactors are particularly widespread. Such processes are described, for example, in EP-A-449092, EP-A-394794, EP-B567818 and DE-A-4102808.

The quality of the products obtained and, in particular, the achievable monomer conversion per pass through the reactor in such high-pressure polymerization processes is dependent, inter alia, on the addition of the correct amount and composition of initiators used (heat generation due to the polymerization) and the heat removal from the reactor. An excessively high initiator concentration leads, firstly, to an excessive rise in temperature in the reactor as a result of the strongly exothermic polymerization reaction, which leads to production malfunctions or at least to decreases in the product quality and also represents a considerable hazard potential for the production operation. Secondly, the use of an unnecessarily large amount of initiator also makes little sense for economic reasons. On the other hand, addition of an amount of initiator which is too low adversely affects the achievable production performance of a plant and leads to products having undesirable molecular and use properties, for examples, gels.

For this reason, efforts have for a long time been made to ensure optimal reaction conditions. Particularly problematical aspects are, firstly, that the various process parameters such as temperature and pressure depend in a complex fashion on the regulating parameters such as volume flow through the reactor and amount and composition of initiator, and, secondly, that delayed response of the regulation has to be avoided.

A starting point as used, for example, in Chem. Ing. Tech. 71,1301 (1999) attempts to describe the behavior of the reaction system in the reactor as precisely as possible in kinetic and process engineering terms in order to be able then to set the operating conditions in an optimal fashion. These prescribed conditions are then maintained as precisely as possible by means of a regulation system.

Another starting point attempts to improve the regulation of the reactor itself. Thus, WO 92/16886 describes a regulation method having improved response behavior. In a tube reactor for preparing LDPE, a process parameter is measured at equidistant time intervals and the value actually to be expected is calculated from the successive measured values via an appropriate algorithm. In the case of unacceptable changes, i.e. if a prescribed temperature is exceeded, regulating actions are taken, for example by reducing the pressure or changing the amount of a peroxide initiator added.

In Hydrocarbon Processing, November 2000, p. 55-58, the reaction system is firstly modeled. This model is in turn used as the basis of a regulation method in which, firstly, the delayed response behavior of a change in the amount of initiator is linked with the immediate effect of a change in the volume flow. Secondly, the temperature dependence of the influence of the changes in the amount of initiator on the reaction rate is also taken into account.

Although these improvements in the regulation method make it possible to improve the response behavior of the reactor to changes in process parameters and thus ensure safer operation, the amounts of initiator and initiator mixtures used either depend on the experience of the production supervisor or are determined by prior simulation of the reaction system in the reactor. Subsequent alteration of the prescribed amount of initiator and the prescribed initiator mixtures during operation of the plant can only be carried out manually and off-line.

Furthermore, EP 750 757 B1 describes a system for optimizing a distillation column in which the costs of starting materials are also taken into account. Here, the composition of starting materials at which an optimum profit is obtained under the prevailing market conditions is calculated in each case.

It is an object of the present invention to overcome the above-described disadvantages of the prior art and to provide a method which ensures safe operation and high conversions and gives reduced production costs.

We have found that this object is achieved by the features of claim 1. The subordinate claims specify advantageous embodiments of the invention.

In the novel method of the type mentioned at the outset, a mixture of at least two polymerization initiators which have different reaction characteristics and provision costs is metered continuously into the tube reactor at the beginning of the reaction zone or zones, at least one physical parameter which has an influence on the polymerization initiator mixture to be used is measured in the reaction zone, the mixture of polymerization initiators which under the prevailing conditions of the physical parameter or parameters measured results in the minimum initiator costs for producing a prescribed amount of polymer product having prescribed product properties is calculated for the reaction zone. At the same time, the mixture is chosen so that safe operation of the tube reactor is ensured. The optimized amount and composition of the polymerization initiators is hereinafter in each case used as the basis of the further metered addition, so that an amount and composition of initiators which has been optimized in terms of initiators is continually fed into the reactor while maintaining the prescribed product specification.

According to the present invention, a mixture comprises at least two polymerization initiators, although temporary introduction of only one initiator into the reactor when the optimization results in addition of only one initiator, i.e. the optimum flows of the other initiators are equal to 0, is not ruled out. The important thing is that the mixture comprises at least two initiators which have different reaction characteristics and provision costs in order to be able to carry out meaningful optimization, with preference being given to all initiators in the mixture differing both in respect of the reaction characteristics and in respect of provision costs.

Reaction characteristics are all properties of the initiators which have an influence on the reaction kinetics and thus on the product properties. Even when the reaction characteristic having the greatest effect is the temperature at which the initiator has a half life of one second (decomposition temperature), it may be emphasized that the reaction characteristics are not restricted to the decomposition temperature. In particular, the effectivenesses of the initiators also represent a reaction characteristic. Interactions with other materials and initiators in the reaction mixture can also represent a reaction characteristic.

For the purposes of the present invention, provision costs or initiator costs are all costs expended in order to introduce the respective initiator into the tube reactor. These can include the purchase prices of the initiators, if the initiators are purchased. Alternatively, the preparation costs are included when the initiators are prepared in-house. Additional costs for formulation, metered addition, etc., can also be taken into account if these costs differ for the various initiators. On the other hand, costs which do not vary between the various initiators can be disregarded, since they do not contribute to optimization.

As physical parameter, it is possible to employ any measured physical parameter which can be measured in the reactor and is coupled with the reaction characteristics of the initiators so as to give an influence on the optimum initiator mixture. The most important physical parameter is the temperature of the reaction mixture in the reactor along the respective reaction zone. The temperature can easily be monitored in the reaction zones or has to be measured in any case for safety reasons. A further advantageous physical parameter is the pressure in the interior of the reactor. Furthermore, it is useful to measure the temperature in the cooling jacket customarily used to remove the heat of reaction.

Preference is given to different reaction characteristics being given by the polymerization initiators of the mixture having different decomposition temperatures and the temperature of the reaction mixture serving as physical parameters.

Preference is also given to providing the tube reactor with at least two reaction zones, i.e. introducing an appropriate initiator mixture at at least two points along the tube reactor. The initiator mixture for the reaction zone is calculated on the basis of the prevailing inlet temperature of the respective reaction zone. While the inlet temperature of the first reaction zone is, due to the upstream preheater, not influenced by the reaction, the inlet temperatures of the subsequent reaction zones alter continually due to fluctuations in heat generation and heat removal, for example as a result of altered purity of the reactants, initiators or additives used or as a result of changed cooling of the tube reactor, in particular due to deposits on the reactor walls or changes in the viscosity of the reaction mixture.

The calculation of the initiator mixture incurring the minimum provision costs is preferably carried out by firstly calculating the actual effectivenesses f of the respective polymerization initiators in the actual mixture from the measured temperature profile of the reaction zones using a kinetic reaction and reactor model. An optimum temperature profile for achieving the prescribed properties of the polymer product is then calculated from the commencement temperatures of the reaction zones following the first reaction zone, with adherence to the maximum permissible temperatures of the reaction mixture. Finally, the initiator mixture which incurs the minimum provision costs per unit polymer product is calculated from the optimum temperature profile and the initiator effectivenesses f.

For the purposes of the present invention, the effectiveness f is the proportion of primary free radicals which are formed from the respective initiator and contribute to initiation of a polymer chain. The calculated effectivenesses can be calibrated and verified from the polymer product by means of an end group analysis known to a person skilled in the art.

In a further advantageous variant of the present invention, the melt flow rate MFR (190° C./2.16 kg) in accordance with ISO 1133 is also measured continuously as product property and taken into account in the calculation of the initiator mixture incurring the minimum provision costs. This is appropriately carried out at the end of the last reaction zone or directly subsequent to the last reaction zone, but can also be carried out, for supplementary purposes, in the respective reaction zones themselves or on granulated samples.

The method of the present invention is particularly advantageous when the metered addition of the polymerization initiator mixtures is carried out continuously and essentially pulsation-free, since this gives a uniform initiator concentration profile and no fluctuations disturb the optimization process.

In the preparation of highly viscose products, e.g. MFR=0.25 g/10 min, it is advantageous to introduce the monomer or monomers not only at the inlet of the tube reactor, but instead to feed in monomers at various points along the reactor. This is particularly preferably carried out at the beginning of the further reaction zones.

The method of the present invention can be used for both the homopolymerization of ethylene and the copolymerization of ethylene with one or more other monomers, provided that these monomers are copolymerizable with ethylene under free-radical conditions under high pressure. Examples of suitable copolymerizable monomers are α, β-unsaturated C₃-C₈-carboxylic acids, in particular maleic acid, fumaric acid, itaconic acid, acrylic acid, methacrylic acid and crotonic acid, derivatives of the α,β-unsaturated C₃-C₈-carboxylic acids, e.g. unsaturated C₃-C₁₅-carboxylic acid esters, in particular esters of C₁-C₆-alkanols, or anhydrides, in particular methyl methacrylate, ethyl methacrylate, n-butyl methacrylate or tert-butyl methacrylate, methyl acrylate, ethyl acrylate, n-butyl acrylate, 2-ethylhexyl acrylate, tert-butyl acrylate, methacrylic anhydride, maleic anhydride or itaconic anhydride, and α-olefins such as propene, 1-butene, 1-pentene, 1-hexene, 1-octene or 1-decene. Vinyl carboxylates, particularly preferably vinyl acetate, can also be used as comonomers. Particularly advantageous comonomers are n-butyl acrylate, acrylic acid and methacrylic acid. The proportion of comonomer or comonomers in the reaction mixture is from 1 to 45% by weight, preferably from 3 to 30% by weight, based on the amount of ethylene. In the case of copolymerization, the further monomers are preferably fed in at a plurality of points along the reactor.

For the purposes of the present invention, polymers are all substances which are made up of at least two monomer units. Among these, preference is given to LDPE polymers having a mean molecular weight Mₙ of above 20,000 g. The method of the present invention can, however, also be advantageously employed in the preparation of oligomers, waxes and polymers having a molecular weight Mₙ of less than 20,000 g.

As initiators for starting the polymerization in the respective reaction zone, it is possible to use, for example, air, oxygen, azo compounds or peroxidic polymerization initiators. Initiation using organic peroxides or azo compounds is a particularly preferred embodiment of the method of the present invention. Examples of suitable organic peroxides are peroxy ester, peroxy ketals, peroxy ketones and peroxy carbonates, e.g. di(2-ethylhexyl) peroxydicarbonate, dicyclohexyl peroxydicarbonate, diacetyl peroxydicarbonate, tert-butylperoxy isopropyl carbonate, di-tert-butyl peroxide, di-tert-amyl peroxide, dicumyl peroxide, 2,5-dimethyl-2,5-di-tert-butylperoxyhexane, tert-butyl cumyl peroxide, 2,5-dimethyl-2,5-di(tert-butylperoxy)hex-3-yne, 1,3-diisopropyl monohydroperoxide or tert-butyl hydroperoxide, didecanoyl peroxide, 2,5-dimethyl-2,5-di(2-ethylhexanoylperoxy)hexane, tert-amylperoxy 2-ethylhexanoate, dibenzoyl peroxide, tert-butylperoxy 2-ethylhexanoate, tert-butylperoxy diethylacetate, tert-butylperoxy diethylisobutyrate, 1,1-di-(tert-butylperoxy)-3,3,5-trimethylcyclohexane, 1,1-di-(tert-butylperoxy) cyclohexane, tert-butyl peroxacetate, cumyl peroxyneodecanoate, tert-amyl peroxyneodecanoate, tert-amyl-peroxypivalate, tert-butyl peroxyneodecanoate, tert-butyl permaleate, tert-butyl peroxypivalate, tert-butyl peroxyisononanoate, diisopropylbenzene hydroperoxide, cumene hydroperoxide, tert-butyl peroxybenzoate, methyl isobutyl ketone hydroperoxide, 3,6,9-triethyl-3,6,9-trimethyl-triperoxocyclononane or 2,2-di-(tert-butylperoxy)-butane. Further suitable polymerization initiators are azoalkanes (diazenes), azodicarboxylic esters, azodicarboxylic dinitriles, such as azobisisobutyronitrile, and also hydrocarbons which decompose by a free-radical mechanism, also referred to as C-C-initiators, e.g. 1,2-diphenyl-1,2-dimethylethane derivatives and 1,1,2,2-tetramethylethane derivatives. It is here possible to use both individual initiators and, preferably, mixtures of various initiators. A wide range of initiators, In particular peroxides, are commercially available, for example the products marketed under the trade names Trigono® or Perkadox® by Akzo Nobel.

In a preferred embodiment of the method of the present invention, peroxidic polymerization initiators used are ones having a relatively high decomposition temperature. Suitable peroxidic polymerization initiators are, for example, 1,1-di(tert-butylperoxy) cyclohexane, 2,2-di(tert-butylperoxy) butane, tert-butyl peroxy-3,5,5-trimethylhexanoate, tert-butyl peroxybenzoate, 2,5-dimethyl-2,5-di-tert-butylperoxyhexane, tert-butyl cumyl peroxide, di-tert-butyl peroxide and 2,5-dimethyl-2,5-di(tert-butylperoxy)hex-3-yne; particular preference is given to using di-tert-butyl peroxide.

The polymerization is preferably carried out in a tube reactor having a plurality of reaction zones, more preferably 2-6 reaction zones, particularly preferably from 3 to 5 reaction zones. The polymerization is initiated in each polymerization zone by addition of the initiators which decompose into free radicals. The tube reactor preferably has a length-to-diameter ratio of >1000.

The initiators can be employed in each zone either individually or as a mixture in concentrations of from 0.1 to 50 moVmetric ton of polyethylene produced, in particular from 0.2 to 20 mol/metric ton. It is often advantageous for the initiators to be used in the dissolved state. Examples of suitable solvents are ketones or aliphatic hydrocarbons, in particular octane, decane and isododecane, and also other saturated C₈ to C₂₅ hydrocarbons. The initiator mixtures are present in proportions of from 2 to 65% by weight, preferably from 5 to 40% by weight and particularly preferably from 10 to 30% by weight, in the solutions. Particular preference is given to using mixtures of initiators which have different decomposition temperatures.

In the method of the present invention, the molar mass of the polymers to be prepared can be controlled in a customary fashion by addition of molecular weight regulators. Examples of suitable regulators are hydrogen, aliphatic and olefinic hydrocarbons, e.g. pentane, hexane, cyclohexane, propene, 1-pentene or 1-hexene, ketones such as acetone, methyl ether ketone (2-butanone), methyl isobutyl ketone, methyl isoamyl ketone, diethyl ketone or diamyl ketone, aldehydes such as formaldehyde, acetaldehyde or propionadehyde and saturated aliphatic alcohols, e.g. methanol, ethanol, propanol, isopropanol or butanol. Particular preference is given to using saturated aliphatic aldehydes, in particular propionaldehyde or, α-olefins, such as propene or 1-hexen. The molecular weight regulator is preferably fed into the reaction mixture upstream of the tube reactor. It can also be introduced together with the polymerization initiator as one or more points along the tube reactor. The addition of the regulator can be incorporated in the optimization process.

The polymerization process to which the method of the present invention is applied is usually carried out at pressures of from 1000 to 4000 bar, with pressures of from 1800 to 3500 bar being preferred and pressures of from 2000 to 3300 bar being particularly preferred. The temperatures are generally in a range from 100 to 350° C., preferably from 140 to 340° C. and very particularly preferably from 150° C. to 320° C., with the copolymerization of ethylene with sensitive or strongly regulating comonomers, in particular free-radically polymerizable carboxylic esters such as vinyl esters, preferably being carried out at temperatures below 230° C. In general, preference is given to a process in which the polymerization temperature is not higher than 320° C.

The flowing reaction mixture generally comprises polyethylene in an amount in the range from 0 to 45% by weight, based on the total weight of the monomers fed into the reactor, usually up to 40% by weight.

Implementation of the method of the present invention requires a model for the reaction system in order to be able to calculate the influence of the various polymerization initiators on the reaction temperature and thus also on the product properties. For this propose, it is usual to use a system of differential equations which should describe the reaction kinetics occurring in the reactor and the material and heat balances as accurately as possible. Such models are prior art and are all based on advanced process controllers which operate according to “first principles” and have been used for some time for the control and regulation of chemical reaction processes. Such reaction models are described, for example, in “Modellierung der Ethylen-Polymerisation im Elenac-Hochdruck-Rohrreaktorverfahren”, F.-O. Mähling, R. Klimesch, M. Schwibach, M. Buback, M. Busch, Chem. Ing. Tech. 71, 1301 (1999), G. Luft, H. Bitsch, H. Seidl, J. Macromol. Sci.-Chem., A11 (6), 1089 (1977) and in M. Busch, Macromol. Theory Simul. 10, 408 (2001).

To calculate the optimum composition of the initiator mixture, the use of a computer-aided tool for the rapid solution of the system of differential equations is indispensable. Many such tools are offered commercially on the market Further details of the “Muscod II” computer program used here may be found in the Muscod II Forschrittsbericht des VDI, Series 3: Verfahrenstechnik, No. 613, 1999, in which the principles and application examples of the program are described in detail.

A further prerequisite for carrying out the method of the present invention is sufficiently fast measurement of the physical parameter in the reactor. To measure the temperature, preference is given to using a temperature probe having a short response time, as is described in WO 97/25601.

Furthermore, the mass flow of the various initiators into the reactor should be continuous and virtually pulsation-free in order to achieve a good result in the regulation method. For this purpose, it is possible to use, for example, the metering device described in WO 00/77055, which ensures rapid, uniform mixing of the polymerization initiator fed in and the reaction mixture.

While the molar mass M_{w} can be influenced very well by the regulator added independently of the initiators, a determination of the product properties, in particular the density and the melt flow rate (MFR), close to production is of great advantage for precise regulation. For this reason, the melt flow rate of the polymerization product is determined on-line at the end of the reactor in a preferred embodiment. To determine the density, samples are taken and the density is calculated from an IR or Raman spectrum. On-line determination of the density is also possible. The methods mentioned are generally known to those skilled in the art and are described in DE 102 37 394 (as yet unpublished). These possible ways of determining product properties close to production can also be incorporated into the regulation process, by which means the proportion of reject product which does not meet the required specification can be reduced further.

In a further advantageous embodiment of the present invention, an autoclave is installed upstream of the tube reactor, which makes a prepolymerization at a lower temperature upwards of about 80° C. possible.

The invention is illustrated below with the aid of the FIGURE, without it being restricted to the embodiments described.

The FIGURE shows a schematic temperature profile (Ordinate) in a tube reactor for the high-pressure polymerization of ethylene having 4 reaction zones (abscissa). The respective reactor has 4 reaction zones which are denoted, from left to right, by the reference numerals 1, 2, 3 and 4. Upstream of the first reaction zone, the reaction mixture is brought to the prescribed inlet temperature of the first reaction zone, T₁^{In} by means of a preheater. At the beginning of the first reaction zone, the first catalyst mixture having the composition A which is initially based on values derived from experience or modeling calculations in order to obtain a suitable temperature profile which is in the range of the working temperatures of the polymerization initiators in the first reaction zone is introduced. As a result of the exothermic polymerization reaction, the temperature of the reaction mixture initially rises to the temperature T₁^{max} and then, after consumption of the polymerization initiators toward the end of the reaction zone, drop to T₁^{out}, which at the same time represents the inlet temperature T₂^{In} of the second reaction zone 2. The next metered addition of polymerization initiators having a composition B is then carried out at this temperature T₂^{In}. This is repeated for each of the reaction zones 2, 3 and 4, until finally the reaction mixture leaving the reaction zone 4 comprises the finished polymerization product, which is depressurized as is customary and worked up with recirculation of unconsumed monomers.

In the four reaction zones 1, 2, 3, 4, temperature sensors by means of which the temperature (regulating parameter) of the reaction mixture is determined are provided at regular intervals. Temperature probes having short response times, as are described, for example, in WO 97/25601, are used. In addition, further reaction parameters, in particular the pressure prevailing in the reactor, can be determined.

Furthermore, the melt flow rate MRF (190° C./2.16 kg) is measured on samples taken at regular intervals or continuously at the end of the reactor, i.e. at the end of the last reaction zone 4, in order to be able to measure deviations from the behavior of the model without any long time delay. In addition, it is possible to determine further product properties, for example, the molar mass M_{w}, the molar mass distribution M_{w}/Mₙ, the degree of branching, etc., close to the process in order to adhere to the prescribed product specification within the prescribed limits. Spectroscopic methods (IR, Raman) or rapid gel permeation chromatography are particularly suitable for this purpose.

The temperatures of the mixture determined by the temperature sensors and the product properties are passed to a central regulating unit. The core of the regulating unit is a simulation and optimization program by means of which the effectivenesses, i.e. the proportion of free radicals which initiate a polymer chain, are firstly calculated from the measured temperatures using a reactor model. The effectivenesses have values in the range from 0 to 1 and can sometimes be below 0.5. The reaction and reactor model used consists of a kinetic part and a process engineering part and is described in “Modellierung der Ethylen-Polymerisation im Elenac-Hochdruck-Rohrreaktorverfahren”, F.-O. Mähling, R. Klimesch, M. Schwibach, M. Buback, M. Busch, Chem. Ing. Tech. 71, 1301 (1999) and M. Busch, Macromol. Theory Simul. 10, 408 (2001). The kinetics presented there can be input directly in the form of differential equations into the simulation software “Muscod II”.

Subsequently, the inlet temperatures T₂^{In}, T₃^{In}, T₄^{In} of the reaction zones 2, 3, 4 following the first reaction zone are used to calculate a temperature profile which is optimal for achieving the prescribed properties and conversion of the polymer product and also the provision costs of the initiators used (target parameters), with the temperatures of the reaction mixture T₂^{max}, T₃^{max}, T₄^{max} not being allowed to exceed the prescribed maximum reactor temperature T^{max}. In principle, it is also possible to include the first reaction zone 1, but the inlet temperature T₁^{In} is virtually constant because of the constant preheating of the reaction mixture by the preheater installed upstream of the first reaction zone 1. It would be interesting to include the first reaction zone 1 if its inlet temperature T₁^{In} were likewise subjected to fluctuations or different maximum temperatures T₁^{max} were frequently sought (e.g. in the case of product or pressure changes).

Finally, the initiator mixture and amount of initiator which are cheapest for the particular optimum temperature profile and by means of which the prescribed product properties can be achieved are calculated for a known amount of each initiator from their initiator effectiveness together with the specific provision costs of the initiators using optimization software for each reaction zone. This is carried out in the present case for the reaction zones, 2, 3, 4. Finally, the metering pumps and metering valves for the various initiators are controlled by the regulating system so that the metered addition corresponds to the optimum amount and composition of initiator in the reactor.

The optimization is input into the regulation, with the required temperature values in the reactor also being continually updated as a function of the initiator costs and effectivenesses. Thus, optimization of the initiators used in the reactor takes place continually during the course of the polymerization reaction, so that the product specification is achieved with the lowest possible financial cost for the initiators used.

As optimization program, use is made of the Muscod II software which has been developed specifically for the optimization of complex chemical processes and is used at the Institut for Wissenschaftliches Rechnen (IWR) in Heidelberg, Germany.

An advantage of this method is that the initiator composition is adapted in the event of temperature or pressure changes so as to achieve both the desired product properties and reduced initiator costs, so that adherence to the required specification for the polymer product is always ensured at reduced production costs.

### EXAMPLES

The polymerization was carried out in a high-pressure tube reactor having a length of 960 m and a diameter of 39 mm for examples 1 to 4 and comparative examples C1 to C4. The polymerization initiators were conveyed as solutions in aliphatic hydrocarbons directly to the feed points on the tube reactor by means of high-pressure piston pumps. The oxygen-free ethylene was compressed in a number of stages to the respective reaction pressure, admixed with propionaldehyde as molar mass regulator and fed via the preheater to the tube reactor.

The heat of reaction liberated in the reaction was removed from the reaction mixture by means of a coolant circuit. The resulting polymer was freed of unreacted ethylene and other low molecular weight compounds in a customary and known manner in treatment units installed downstream of the reactor and discharged and pelletized via an extruder and granulator. Unreacted ethylene was purified in a number of stages and recirculated to the suction side of the compressor. Details may be found in Ullmans Encyclopädie der technischen Chemie, Vol. 19, pp. 169-178 (1980).

All examples were carried out using an ethylene throughput of 30 metric tons/h and a reactor inlet pressure of 2900 bar.

The tube reactor had 3 reaction zones and a prescribed amount and composition of initiator was fed into the reactor at the beginning of each zone. Mixtures of 5 different types of peroxide initiator were used in each case; the composition of these mixtures was optimized on the basis of the control parameters temperature (T), pressure (p) and amounts of peroxide (PO). The types of initiator are characterized in terms of their half lives and use temperature ranges in the following table.

| Peroxide | 100% purchase | Tₘᵢₙ-Tₘₐₓ | T for half life |
|---|---|---|---|
| type | price/kg [EUR/kg] | [° C.] | of 1 sec. [° C.] |
| A | 14.00 | 130-190 | 156 |
| B | 8.50 | 160-220 | 178 |
| C | 14.00 | 190-260 | 216 |
| D | 3.50 | 235-305 | 252 |
| E | 30.00 | 240-320 | 264 |

The initiator types A and B were used only in reaction zone 1 in all examples because of the low decomposition temperature.

The results are shown in the following table. Examples 1 to 4 according to the present invention were in each case carried out using the optimizer described, while comparative examples C1 to C4 were carried out without optimizers. Optimization was carried out using the commercially available software Muscod II under a Linux operating system.

| | | | | | | | | | Specific |
|---|---|---|---|---|---|---|---|---|---|
| | | | | | | | | Monomer | initiator costs |
| Experiment | Time | T₁ⁱⁿ | T₁^{max} | T₂ⁱⁿ | T₂^{max} | T₃ⁱⁿ | T₃^{max} | conversion | EUR/metric |
| No. | h | ° C. | °C. | ° C. | ° C. | ° C. | °C. | % | ton of product |
| 1 | 0.0 | 155 | 300 | 253 | 309 | 256 | 310 | 27.8 | 1.52 |
| 2 | 0.5 | 154 | 302 | 254 | 309 | 255 | 310 | 27.7 | 1.53 |
| 3 | 12 | 155 | 300 | 247 | 308 | 248 | 309 | 28.6 | 1.44 |
| 4 | 24 | 155 | 301 | 245 | 309 | 247 | 310 | 28.8 | 1.40 |
| C1 | 0.0 | 155 | 299 | 254 | 309 | 260 | 311 | 27.9 | 1.93 |
| C2 | 0.5 | 155 | 297 | 250 | 309 | 255 | 310 | 28.1 | 1.90 |
| C3 | 12 | 155 | 304 | 248 | 311 | 254 | 310 | 28.6 | 1.85 |
| C4 | 24 | 154 | 302 | 246 | 307 | 248 | 308 | 28.3 | 1.87 |

The use of the optimizer made it possible to achieve a reduction in the specific initiator costs of over 20% at all points in time of the courses of the experiments while maintaining the desired product quality. The monomer conversion was increased slightly and the maximum temperatures to be adhered to were subject to smaller fluctuations than in the comparative examples.

The third batch of example according to the present invention and comparative example was in each case examined in application terms. The results are shown in the following table. The optical properties could clearly be improved by use of the optimizer.

| | | MFR | | | | |
|---|---|---|---|---|---|---|
| Experiment | Density | g/10 | | | Drawability | Gloss |
| No. | kg/m³ | min | Scattering | Haze | m/min | (20°) |
| 3-4 | 924.3 | 0.88 | 15.7 | 6.4 | 20 | 50 |
| C3-C4 | 924.1 | 0.85 | 19.4 | 8.0 | 21 | 38 |

Blown films were produced in a customary manner from the polymers (cf. Ullmanns Encyclopedie der technischen Chemie, Vol. 11, p. 673 (1980)), and the use properties of these were determined by the following methods:

| | |
|---|---|
| Density: | DIN ISO 1183 |
| MFR: | Melt flow rate in accordance with ISO 1133 at 190° C. |
| | and 2.16 kg |
| Scattering: | DIN 53490 |
| Haze: | ASTM D 1003 |
| Gloss: | DIN 67530 |

The drawability of the blown film was determined in a customary and known manner during taking-off and winding-up in blown film extrusion. The take-off speed was increased by 2 m/min at intervals of 20 s until rupture of the film occurred.

1. A method of controlling the process for the continuous free-radical polymerization of ethylene in the presence or absence of comonomers in a tube reactor having at least one reaction zone (1, 2, 3, 4) at pressures above 1000 bar and temperatures in the range from 100 to 400° C., comprising:
a mixture of at least two polymerization initiators which have different reaction characteristics and provision costs are metered continuously into the tube reactor at the beginning of the reaction zone (1, 2, 3, 4),
at least one physical parameter which has an influence on the polymerization initiator mixture to be used is measured in the reaction zone (1, 2, 3, 4),
the mixture of polymerization initiators which under the prevailing conditions of the physical parameter or parameters measured results in the minimum initiator costs for producing a prescribed amount of polymer product having prescribed product properties and ensures safe operation of the tube reactor is calculated for the reaction zone (1, 2, 3, 4), and
the calculated amount and composition of the polymerization initiators is used as the basis for the further metered addition.

2. A method as claimed in claim 1, wherein the polymerization initiators of the mixture have different decomposition temperatures as reaction characteristic and the temperature is measured as physical parameter.

3. A method as claimed in claim 2, wherein the tube reactor has at least 2 reaction zones (1, 2, 3, 4) and the initiator mixture for at least one reaction zone (2, 3, 4) is calculated on the basis of the prevailing inlet temperature (T₂ⁱⁿ, T₃ⁱⁿ, T₄ⁱⁿ) of the reaction zone (2, 3, 4).

4. A method as claimed in claim 3, wherein the calculation of the initiator mixture incurring the minimum provision costs is carried out using a kinetic reaction and reactor model by
calculating the actual effectivenesses f of the respective polymerization initiators in the actual mixture from the measured temperature profile of the reaction zones (1, 2, 3, 4),
calculating an optimum temperature profile for achieving the described properties of the polymer product from the commencement temperatures (T₂ⁱⁿ, T₃ⁱⁿ, T₄ⁱⁿ) of the reaction zones (2, 3, 4) following the first reaction zone with adherence to the maximum permissible temperatures of the reaction mixture (T₂^{max}, T₃^{max}, T₄^{max}) and
calculating the initiator mixture which incurs the minimum provision costs per unit polymer product from the optimum temperature profile and the initiator effectivenesses f.

5. A method as claimed in claim 1, wherein the melt flow rate MFR (2.16/190) is measured continuously in accordance with ISO 1133 as product property at the end of the last reaction zone (4) or directly subsequent to the last reaction zone (4) and is taken into account in the calculation of the initiator mixture incurring the minimum provision costs.

6. A method as claimed in claim 1, wherein the metered addition of the polymerization initiator mixtures is carried out continuously and in an essentially pulsation-free manner.

7. A method as claimed in claim 1, wherein the tube reactor has a length-to-diameter ratio of >1000.

8. A method as claimed in claim 1, wherein further monomers are fed in at a plurality of points along the reactor.

9. A method as claimed in claim 1, wherein a polymerization autoclave is installed upstream of the tube reactor.
